(19) United States
(12) Patent Application Publication
(10) Pub. No.: US 2008/0075198 A1
(43) Pub. Date: Mar. 27, 2008

(54) Method for I/Q signal adjustment

(76) Inventors: Chi-Tung Chang, Taipei City (TW); Chieh-Tsao Hwang, Taipei City (TW); Chih-Hao Lai, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/613,177

(22) Filed: Dec. 19, 2006

(30) Foreign Application Priority Data
Sep. 25, 2006 (TW) 095135403

(51) Int. Cl. H04L 27/20

(52) U.S. Cl. 375/308

(57) ABSTRACT

A method for I/Q adjustment is disclosed. The method includes delaying phases of an in-phase signal and a quadrature signal with a predetermined angle for generating an in-phase delay signal and a quadrature delay signal; adjusting magnitudes of the in-phase signal, the quadrature signal, the in-phase delay signal, and the quadrature delay signal according to a magnitude difference signal and a phase control signal; adding the adjusted in-phase signal and the adjusted in-phase delay signal; and adding the adjusted quadrature signal and the adjusted quadrature delay signal.

### BACKGROUND OF THE INVENTION

1. Field of the Invention

The present invention provides a method for adjusting I/Q signals, and more particularly, the present invention provides a method for adjusting the phases and the amplitudes of the I/Q signals in a communication system.

2. Description of the Prior Art

In a complex communication system, the balance between in-phase signals (I signal) and quadrature-phase signals (Q signal) is very important to the quality of communication. For example, in a direct conversion architecture transceiver, the imbalance between the I signal and the Q signal leads to performance of the error vector magnitude (EVM) becoming worse. Besides, in a super heterodyne transceiver, the imbalance between the I signal and the Q signal also declines the performance of the mixer for filtering out the signal of imaginary parts.

The definition of the balance between the I signal and the Q signal is: 1. the amplitude of the I signal equals that of the Q signal; 2. the phase of the I signal leads 90 degrees ahead of that of the Q signal. In general, the reasons of the imbalance between the I signal and the Q signal can be contributed to the mismatching of the active/passive devices, layout paths, and load impedance.

Please refer to FIG. 1. FIG. 1 is a diagram illustrating a transmitter 100 of a direct conversion transceiver. As shown in FIG. 1, the transmitter 110 of the direct conversion transceiver comprises a baseband (BB) module 100 and a RF module 120. The RF module 120 comprises 2 mixers M1 and M2, an addition circuit S1, a local oscillator L1, and a delay circuit D1. The mixer M1 comprises 2 input nodes: one input node is connected to an output node of the BB module 110 for receiving the I signal I1; the other input node is connected to the output node of the local oscillator L1 for receiving the I signal I2 outputted from the local oscillator L1. The mixer M2 comprises 2 input nodes: one input node is connected to another output node of the BB module 110 for receiving a Q signal Q1; the other end is connected to the output node of the delay circuit D1 for receiving a Q signal Q2 outputted from the delay circuit D1. The input node of the delay circuit D1 is connected to the output node of the local oscillator L1 for delaying the phase of the I signal I2 by 90 degrees. The mixer M1 converts the received I signals 11 and 12 and outputs an I signal I3. The mixer M2 converts the received Q signals Q1 and Q2 and outputs a Q signal Q3. The addition circuit S1 comprises 2 input nodes: one input node is connected to the output node of the mixer M1 for receiving the I signal I3; the other node is connected to the output node of the mixer M2 for receiving the Q signal Q3. The addition circuit S1 adds the I signal I3 to the Q signal Q3 for outputting a signal C1. If the I signal I3 and the Q signal Q3 are imbalanced, the problems described above rise during the process of generating signal C1. The imbalance between the I signal I3 and the Q signal Q3 may contribute to the mismatch of the mixers M1 and M2, the imbalance between the I signal I2 outputted from the local oscillator I1 and the Q signal Q2 outputted from the delay circuit D1, or the imbalance between the I signal I1 and the Q signal Q1 outputted from the BB module 110. Therefore, the imbalance between the I signal I3 and the Q signal Q3 has to be calibrated for improving the quality of the communication.

### SUMMARY OF THE INVENTION

The present invention provides a method for adjusting a set of an in-phase signal and a quadrature-phase signal. The method comprises receiving a phase control signal; receiving an amplitude control signal; receiving a first in-phase signal; delaying the first in-phase signal by a predetermined angle for generating a first delayed in-phase signal; adjusting an amplitude of the first in-phase signal for generating a second in-phase signal according to the phase control signal and the amplitude control signal; adjusting an amplitude of the first delayed in-phase signal for generating a second delayed in-phase signal according to the phase control signal and the amplitude control signal; adding the second in-phase signal to the second delayed in-phase signal for generating a third in-phase signal; outputting the third in-phase signal; receiving a first quadrature-phase signal; delaying the first quadrature-phase signal by a predetermined angle for generating a first delayed quadrature-phase signal; adjusting an amplitude of the first quadrature-phase signal for generating a second quadrature-phase signal according to the phase control signal and the amplitude control signal; adjusting an amplitude of the first delayed quadrature-phase signal for generating a second delayed quadrature-phase signal according to the phase control signal and the amplitude control signal; adding the second quadrature-phase signal to the second delayed quadrature-phase signal for generating a third quadrature-phase signal; and outputting the third quadrature-phase signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a transmitter of a direct conversion transceiver 100.

FIG. 2 is a diagram illustrating an I/Q calibration system 200 of a first embodiment of the present invention.

FIG. 3 is a detailed diagram illustrating the calibration system 200 of the present invention.

FIG. 4 is a flowchart of a method for adjusting the I signal/Q signal 400 of the present invention.

FIG. 5 is a vector diagram illustrating step 415 of the flowchart of FIG. 4.

FIG. 6 is a vector diagram illustrating step 425.

FIG. 7 is a vector diagram illustrating step 430 to step 445. FIG. 8 is a vector diagram illustrating step 430 to step 445.

FIG. 9 is a vector diagram illustrating step 430 to step 445.

FIG. 10 is a vector diagram illustrating step 430 to step 445.

FIG. 11 is a circuit Diagram illustrating parts of components of the calibration system 200.

FIG. 12 is a diagram illustrating a first embodiment of the gain adjusting module 110 of the present invention.

FIG. 13 is a diagram illustrating a second embodiment of the calibration system 200 of the present invention.

FIG. 14 is a diagram illustrating a transmitter of a direct conversion transceiver 1400.

FIG. 15 is a diagram illustrating transmitter of a direct conversion transceiver 1500.

### DETAILED DESCRIPTION

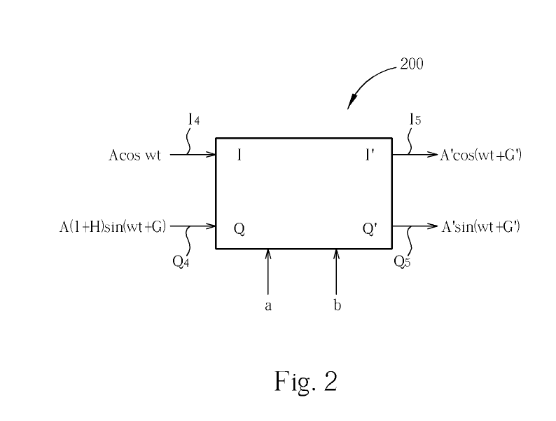

Please refer to FIG. 2. FIG. 2 is a diagram illustrating an I/Q calibration system 200 of a first embodiment of the present invention. As shown in FIG. 2, the calibration system 200 comprises 4 input nodes, 2 output nodes. In the calibration system 200, 2 of the input nodes are disposed respectively for receiving an I signal I4 and a Q signal Q4, the other 2 of the input nodes are disposed respectively for receiving an amplitude control parameter a and a phase control parameter b, and the two output nodes are disposed respectively for outputting the adjusted I signal I5 and Q signal Q5. Before entering the calibration system 200, the I signal I4 is assumed to be A cos(wt) and the Q signal Q4 is assumed to be A(1+H)sin(wt+G), which are imbalanced with each other. The HA represents an amplitude imbalance parameter and the G represents an phase imbalance parameter. After being adjusted in the calibration system 200, the outputted I signal I5 and Q signal Q5 respectively are A′ cos(wt+G′) and A′ sin(wt+G′), which are calibrated and balanced to each other. The calibration system 200 adjusts the I signal I4 and the Q signal Q4 according to the control parameters a and b.

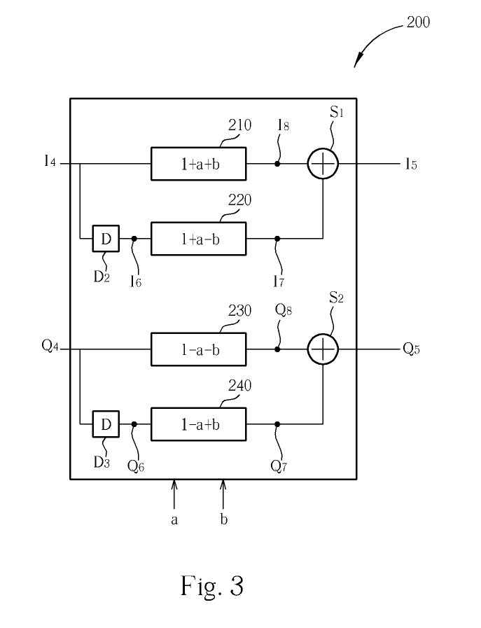

Please refer to FIG. 3. FIG. 3 is a detailed diagram illustrating the calibration system 200 of the present invention. As shown in FIG. 3, the calibration system 200 comprises 2 delay circuits D2 and D3, 4 amplifiers 210-240, and 2 addition circuits S1 and S2. The input node of the delay circuit D2 is connected to the input node of the calibration system 200 for receiving the I signal I4, delaying the phase of the I signal by a predetermined angle K, and then outputting a delayed I signal I6. The input node of the delay circuit D3 is connected to the input node of the calibration system 200 for receiving the Q signal Q4, delaying the phase of the Q signal Q4 by the predetermined angle K, and then outputting a delay Q signal Q6. The input node of the amplifier 210 is connected to the input node of the calibration system 200 for receiving the I signal I4, adjusting the amplitude of the I signal I4 according to the parameters a and b, and then outputting an I signal I8. The input node of the amplifier 220 is connected to the output node of the delay circuit D2 for receiving the delayed I signal I6, adjusting the amplitude of the delayed I signal I6, and then outputting a delayed I signal I7. The input node of the amplified 230 is connected to the input node of the calibration system 200 for receiving the Q signal Q4, adjusting the amplitude of the Q signal Q4 according to the parameters a and b, and then outputting a Q signal Q8. The input node of the amplifier 240 is connected to the output node of the delay circuit D3 for receiving the delayed Q signal Q6, adjusting the amplitude of the delayed Q signal Q6 according to the parameters a and b, and then outputting a delayed Q signal Q7. The input nodes of the addition circuit S1 are connected to the output nodes of the amplifiers 210 and 220 for receiving the I signals 18 and 17, adds the signal I8 to the signal I7, and then outputting the result, I signal I5. The input nodes of the addition circuit S2 are respectively connected to the output nodes of the amplifiers 230 and 240 for receiving the Q signals Q8 and Q9, adds the signal Q8 to the signal Q7, and then outputting the result, the Q signal Q5.

Please continue referring to FIG. 3. In FIG. 3, the amplifier 210 amplifies the I signal I4 for (1+a+b) times according to the parameters a and b; the amplifier 220 amplifies the delayed I signal I6 for (1+a−b) times according to the parameters a and b; the amplifier 230 amplifies the Q signal Q4 for (1−a−b) times according to the parameters a and b; the amplifier 240 amplifies the delayed Q signal Q6 for (1−a+b) times according to the parameters a and b. The parameters a and b can respectively be proportional to the amplitude control signal HA of the I signal I4 and Q signal Q4 and phase control signal G. For example, the parameters a and b can respectively be HA/2 and G/3. Thus, the calibration system 200 executes adjustment on the I signal I4 and Q signal Q4 according to the amplitude difference HA and the phase control signal G.

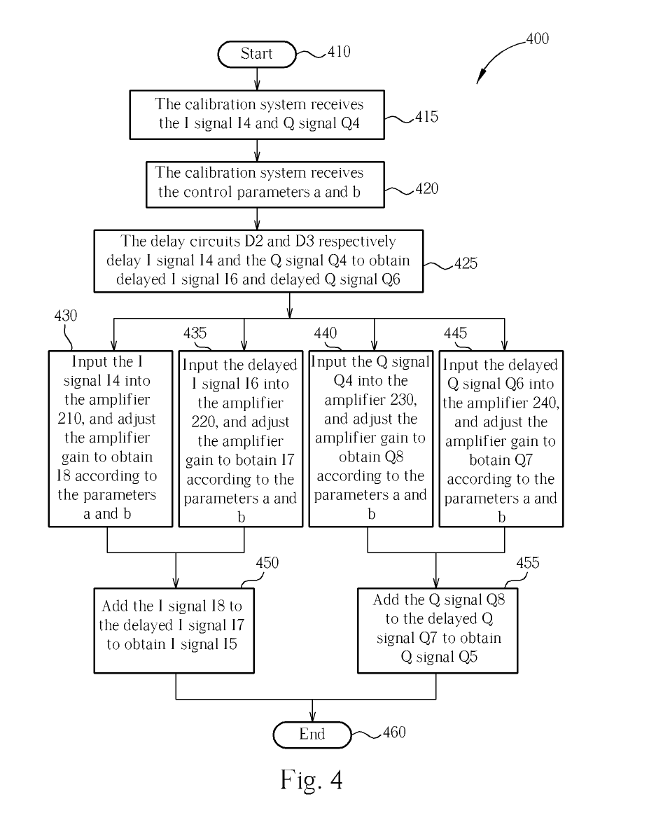

Please refer to FIG. 4. FIG. 4 is a flowchart of a method 400 for adjusting the I signal/Q signal of the present invention. The steps are described as follows:

Step 410: Start;

Step 415: The calibration system 200 receives the I signal I4 and the Q signal Q4;

Step 420: The calibration system 200 receives the parameters a and b;

Step 425: The delay circuits D1 and D2 respectively delay the I signal I4 and the Q signal Q4 by a predetermined angle K for generating the delayed I signal I6 and the delayed Q signal Q6;

Step 430: Input the I signal I4 into the amplifier 210, adjust the gain of the amplifier 210 according to the parameters a and b, and then output the I signal I8;

Step 435: Input the delayed I signal I6 into the amplifier 220, adjust the gain of the amplifier 220 according to the parameters a and b, and then output the delayed I signal I7;

Step 440: Input the Q signal Q4 into the amplifier 230, adjust the gain of the amplifier 230 according to the parameters a and b, and then output the Q signal Q8;

Step 445: Input the delayed Q signal Q6 into the amplifier 240, adjust the gain of the amplifier 240 according to the parameters a and b, and then output the delayed Q signal Q7;

Step 450: Add the I signal I8 to the delayed I signal I7 for outputting the I signal I5;

Step 455: Add the Q signal Q8 to the delayed Q signal Q7 for outputting the Q signal Q5;

Step 460: End.

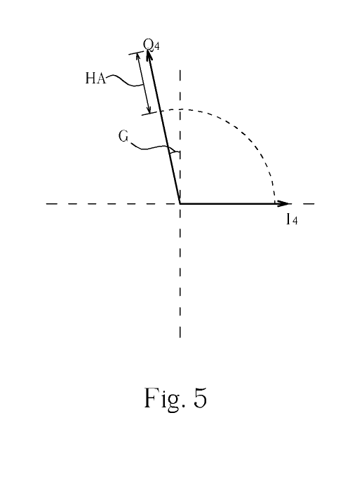

Please refer to FIG. 5. FIG. 5 is a vector diagram illustrating step 415. As shown in FIG. 5, the calibration system 200 receives an I signal I4 and a Q signal Q4. The amplitude mismatching difference between the I signal I4 and the Q signal Q4 is HA. The phase mismatching difference between the I signal I4 and the Q signal Q4 is G.

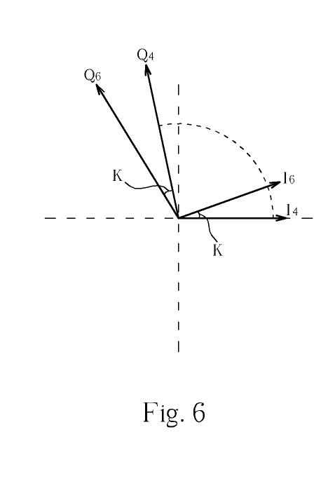

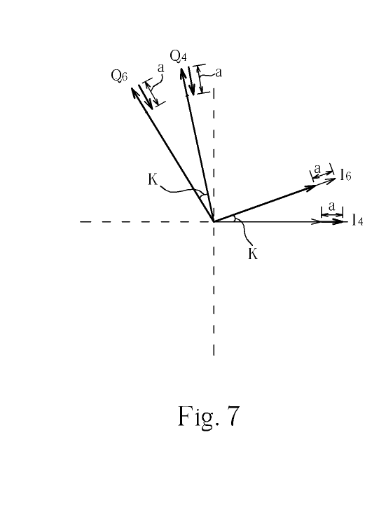

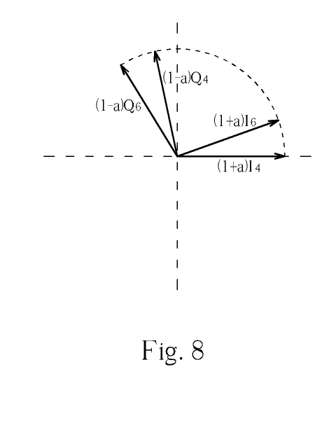

FIG. 6 is a vector diagram illustrating step 425. As shown in FIG. 6, the phase of the I signal I4 is delayed a phase with the predetermined angle K for generating the delayed I signal I6; the phase of the Q signal Q4 is delayed a phase with the predetermined angle K for generating the delayed Q signal Q6. FIG. 7 is a vector diagram illustrating step 430 to step 445. As shown in FIG. 7, the original and delayed signals in FIG. 6 are adjusted according to the parameter a: the amplitudes of the I signal I4 and the delayed I signal I6 are amplified for (1+a) times; the amplitudes of the Q signal Q4 and the delayed Q signal Q6 are amplified for (1−a) times to obtain the amplitude of (1+a)I4 equals to (1+a)I6, (1−a)Q4, and (1−a)Q6, which are shown in FIG. 8.

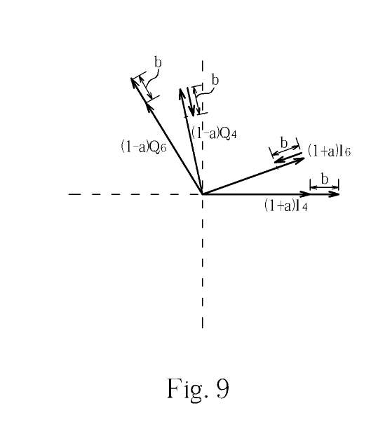

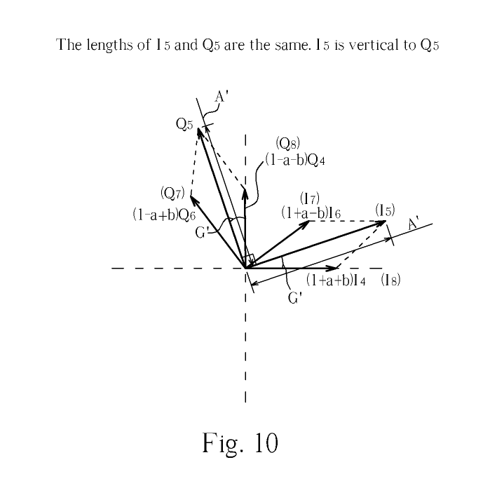

FIG. 9 is a vector diagram illustrating step 430 to step 445. As shown in FIG. 9, the signals in FIG. 8 are respectively again adjusted according to the parameter b: the I signal I4 which is amplified by (1+a) times is finally amplified by (1+a+b) times for generating the I signal I8; the delayed I signal I6 amplified for (1+a) times is finally amplified by (1+a−b) times for generating the I signal I7; the Q signal Q4 amplified for (1−a) times is finally amplified by (1−a−b) times for generating the Q signal Q8; the delayed Q signal Q6 amplified by (1−a) times is finally amplified by (1−a+b) times for generating the delayed Q signal Q7. FIG. 10 is a vector diagram illustrating step 430 to step 445. As shown in FIG. 10, the I signal I8 generated in FIG. 9 is added to the delayed I signal I7 for generating the output I signal I5; the Q signal Q8 generated in FIG. 9 is added to the delayed Q signal Q7 for generating the output Q signal Q5. Thus, the I signal I5 is A′ cos(ωt+G′) while the Q signal Q5 is A′ sin(ωt+G′).

From FIG. 5 to FIG. 10 shows that the parameter a is designed for adjusting the amplitude difference between the I signal I4 and the Q signal Q4, and the parameter b is designed for adjusting the phase difference between the I signal I4 and the Q signal Q4. To every I and Q imbalanced amplitude and phase, there is only one specified set of a and b to calibrate them to balanced I and Q signal. If the I signal I4 and the Q signal Q4 are needed to be calibrated, we only need to set the parameters a and b to obtain the balanced I signal and the Q signal according to the steps described above instead of repeating a lot of recursive steps to find the optimized solution. Besides, from FIG. 7 and FIG. 9, the parameters a and b are respectively designed for adjusting the amplitude difference and the phase difference between the I signal I4 and the Q signal Q4, which means that the amplitude adjusting process and the phase adjusting process can be independent. That is, when adjusting the I signal I4 and the Q signal Q4, the amplitude adjusting process is executed before the phase adjusting process, or, the phase adjusting process is executed before the amplitude adjusting process. In this way, the execution of the amplitude adjusting process according to the parameter a does not affect the execution of the phase adjusting process according to the parameter b, and vice versa.

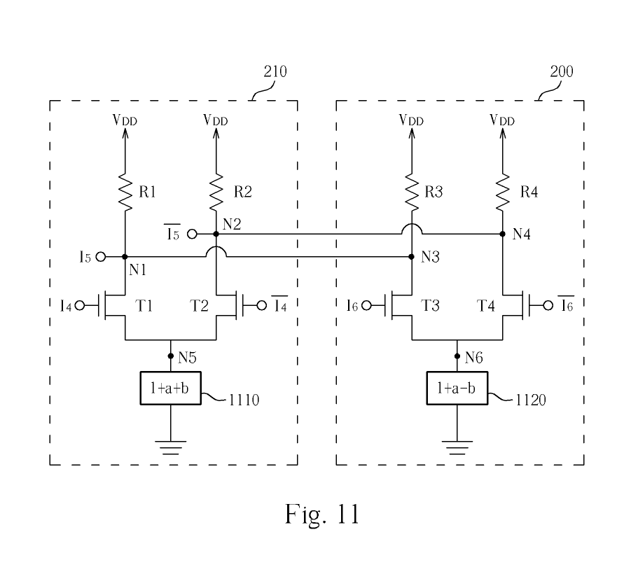

Please refer to FIG. 11, which is a design example to realize IQ calibration system 200. FIG. 11 is a circuit Diagram illustrating parts of the components 210, 220, 230, 240, S1, and S2 of the calibration system 200. FIG. 11 only illustrates the part of adjusting the I signal I4 and the delayed I signal I6. As for the part of adjusting the Q signal Q4 and the delayed Q signal Q6, it is similar to what is illustrated in FIG. 11, and is therefore omitted. In FIG. 11, the I signal I4 is driven by a differential method and represented by I4 and I̅4̅. Similarly, the delayed signal I6 is represented by I6 and I̅6̅.

Please continue refer to FIG. 11. The amplifier 210 comprises a power source VDD, two resistors R1 and R2, two transistors T1 and T2, and a gain adjusting module 1110. The resistor R1 is connected between the power source VDD and node N1. The resistor R2 is connected between the power source VDD and node N2. The transistor T1 is connected between nodes N5 and node N1 wherein the input node of the transistor T1 receives the I signal I4. The transistor T2 is connected between nodes N5 and node N2 wherein the transistor T2 receives the I signal I̅4̅. The gain adjusting module 1110 is connected between node N5 and ground. The amplifier 220 comprises a power source VDD, two resistors R3 and R4, two transistors T3 and T4, and a gain adjusting module 1120. The resistor R3 is connected between the power source VDD and node N3. The resistor R4 is connected between the power source VDD and node N4. The transistor T3 is connected between the nodes N6 and N3 wherein the input node of the transistor T3 receives the I signal I6. The transistor T4 is connected between nodes N6 and node N4 wherein the transistor T4 receives the I signal I̅6̅. The gain adjusting module 1120 is connected between the node N6 and the ground.

Please continue referring to FIG. 11. The transistor T1 receives the I signal I4, amplifies the I signal I4 according to the gain provided by the gain adjusting module 1110 so that the I signal I8 is obtained at the node N1. Similarly, at the node N2, the I signal I̅8̅ is obtained. The transistor T3 receives the delayed I signal I6, amplifies the I signal I6 according to the gain provided by the gain adjusting module 120. Thus, the delayed I signal I7 is obtained at the node N3. Similarly, at the node N4, the delayed I signal I7 is obtained. And because the node N1 is connected to the node N3, the I signal I8 is added to the delayed I signal I7, which realizes the function of the addition circuit S1, and the I signal I5 is obtained. Similarly, because the node N2 is connected to the node N4, the I signal I8 is added to the delayed I signal I7, which realizes the function of the addition circuit S1, and the I signal I5 is obtained.

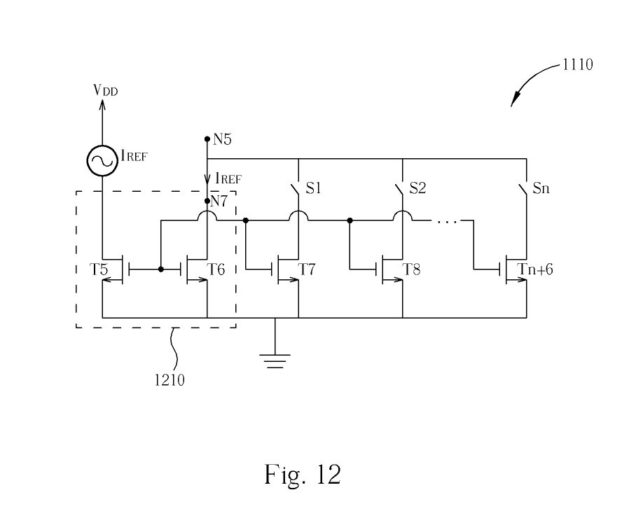

Please refer to FIG. 12. FIG. 12 is a diagram illustrating a first embodiment of the gain adjusting module 1110 of the present invention. The gain adjusting module 1110 comprises a current mirror 1210, a plurality of transistors, and a plurality of switches S1 to Sn. The current mirror 1210 comprises two transistors T5 and T6, a power source VDD, and a reference current IREF. The transistor T5 is connected between the reference current IREF and the ground. The gate of the transistor T6 is connected to the gate of the transistor T5 which the other end of the transistor T6 is connected to the ground. Thus, the transistor T6 can output a current with the same size as the reference current IREF at the node N7. Similarly, the transistor T7-Tₙ₊₆ can also output the current with the same size as the reference current IREF. Therefore, if all of the switches S1-Sn are turned on, all the currents of the transistors T6-Tₙ₊₆ can flow to the node N5 so that the current flow through the node N5 sizes at (N+1)IREF. And if all the switches S1-Sn are turned off, the transistors T7-Tₙ₊₆ cannot provided current flow to the node N5 so that the current flows through the node N5 only sizes at 1IREF. In this way, by controlling the switches S1-Sn, the size of the current flows through the node N5 is controlled. Please go back to FIG. 11, the size of the current flows through the node N5 further controls the gains of the transistor T1 and T2. Therefore, the gains of the transistors T1 and T2 can be controlled by controlling the switches S1-Sn. And the parameters a and b represent the amounts the turned-on switches of the switches S1-Sn so that we can adjust the I signals I8 and I̅8̅ to the size we need by controlling the values of the parameters a and b.

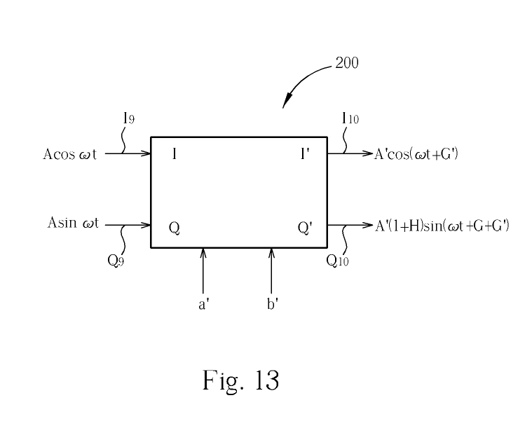

Please refer to FIG. 13. FIG. 13 is a diagram illustrating a second embodiment of the calibration system 200 of the present invention. As shown in FIG. 13, the calibration system 200 comprises four input nodes and two output nodes. The two input nodes are respectively disposed for receiving the I signal I9 and the Q signal Q9 while the other two input nodes are respectively disposed for receiving the parameters a and b. The two output nodes are respectively for outputting the adjusted I signal I10 and the adjusted Q signal Q10. The I signal I9 is A cos(wt) and the Q signal Q9 is A sin(wt), which is balanced to the I signal I9. And after being adjusted in the calibration system 200, the outputted I signal I10 and the Q signal Q10 respectively are A′ cos(wt+G) and A′(1+H)sin(wt+G+G′), which is imbalanced with the I signal I10. The calibration system 200 respectively adjusts the I signal I9 and the Q signal Q9 according to the parameters a and b. That proves the calibration system 200 can adjust a set of balanced I signals and Q signals to be a set of imbalanced I signals and Q signals, or a set of imbalanced I signals and Q signals to be a set of balanced I signals and Q signals according to the parameters a and b.

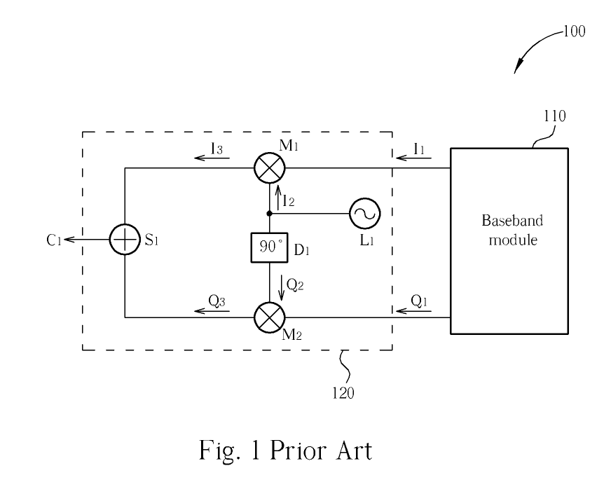

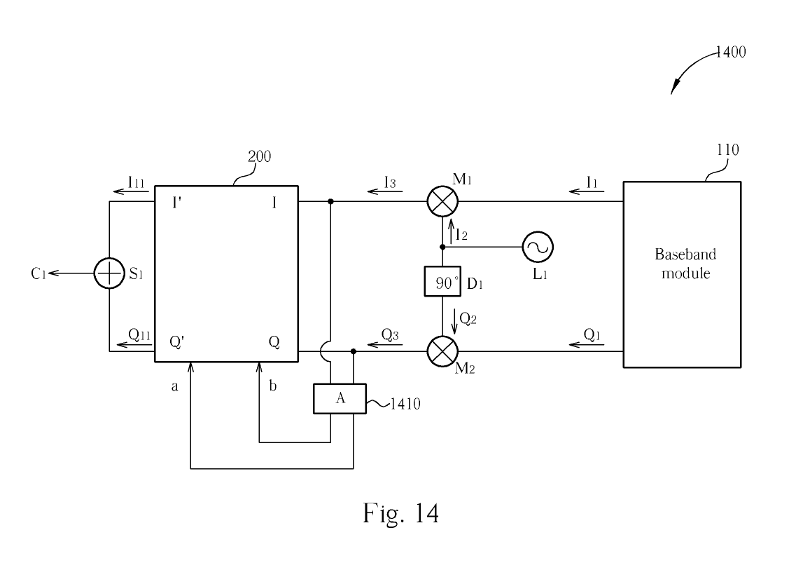

Please refer to FIG. 14. FIG. 14 is a diagram illustrating a transmitter 1400 of a direct conversion transceiver. The components in FIG. 14 are similar to FIG. 1, and the same parts as FIG. 1 are omitted. The difference in FIG. 14 is that in FIG. 14, the calibration system 200 and the vector analyzer 1410 are included. A first input node of the calibration system 200 is connected to the output node of the mixer M1 for receiving the I signal I3; a second input node of the calibration system 200 is connected to the output node of the mixer M2 for receiving the Q signal Q3; a third input node and a fourth input node of the calibration system 200 are connected to the two output nodes of the vector analyzer 1410 for respectively receiving the parameters a and b; a first output node of the calibration system 200 is connected to one input node of the addition circuit S1 for outputting the adjusted I signal I11 to the addition circuit S1; a second output node of the calibration system 200 is connected to the other input node of the addition circuit S1 for outputting the adjusted Q signal Q11 to the addition circuit S1. One input node of the vector analyzer 1410 is connected to the output node of the mixer M1 for receiving the I signal I3; the other input node of the vector analyzer 1410 is connected to the output node of the mixer M2 for receiving the Q signal Q3; the two output nodes of the vector analyzer 1410 are connected to the two input nodes of the calibration system 200 for transmitting the parameters a and b. The vector analyzer 1410 receives the I signal I3 and the Q signal Q3, analyses the amplitude difference and the phase difference between the two signals 13 and Q3, and accordingly transmits the parameters a and b to the calibration system 200. Then the calibration system 200 adjusts the I signal I3 and the Q signal Q3 according to the received parameters a and b for outputting a set of balanced I signal I11 and Q signal Q11 to the addition circuit S1. The addition circuit S1 adds the balanced I signal I11 to the Q signal Q11 for outputting the signal C1 so that the communication quality is improved.

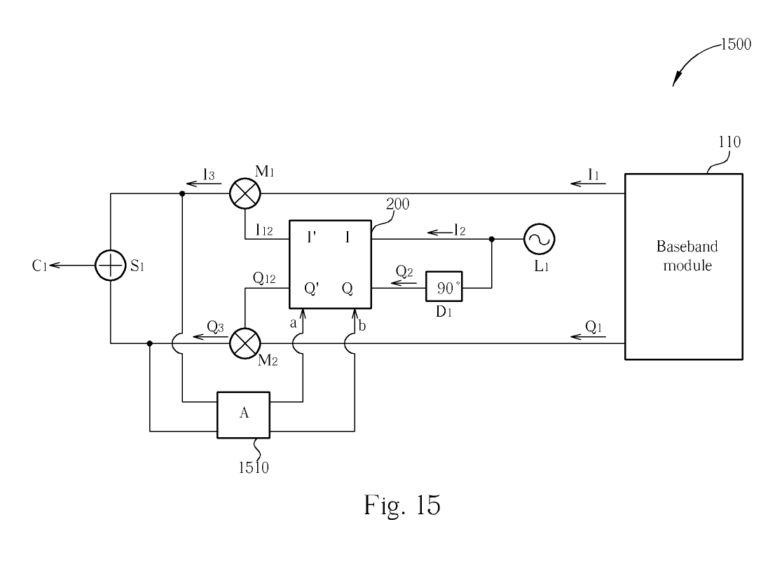

Please refer to FIG. 15. FIG. 15 is a diagram illustrating transmitter 1500 of a direct conversion transceiver. The components in FIG. 15 are similar to those in FIG. 1. The difference between FIG. 15 and FIG. 1 is that in FIG. 15, a calibration system 200 and a vector analyzer 1510 are included. A first input node of the calibration system 200 is connected to the output node of the local oscillator L1 for receiving the I signal I2; a second input node of the calibration system 200 is connected to the output node of the delay circuit D1 for receiving the Q signal Q2; a third and a fourth input nodes of the calibration system 200 are respectively connected to the two output nodes of the vector analyzer 1510 for respectively receiving the parameters a and b; one output node of the calibration system 200 is connected to the mixer M1 for outputting the adjusted I signal I12 to the mixer M1; the other output node of the calibration system 200 is connected to the input node of the mixer M2 for outputting the adjusted Q signal Q12 to the mixer M2. One input node of the vector analyzer 1510 is connected to the output node of the mixer M1 for receiving the I signal I3; the other input node of the vector analyzer 1510 is connected to the output node of the mixer M2 for receiving the Q signal Q3; the two output nodes of the vector analyzer 1510 are respectively connected to the two output nodes of the calibration system 200 for transmitting the parameters a and b. The vector analyzer 1510 receives the I signal I3 and the Q signal Q3, analyses the amplitude difference and the phase difference between the two signal, and then accordingly outputs the parameters a and b to the calibration system 200. The calibration system 200 receives the I signal I2 and the Q signal Q2, adjusts the I signal I2 and the Q signal Q2 according to the received parameters a and b, and outputs the adjusted I signal I12 and the adjusted Q signal Q12 respectively to the mixers M1 and M2. The mixer M1 mixes the I signals 11 and 112 for generating the I signal I3. The mixer M2 mixes the Q signals Q1 and Q12 for generating the Q signal Q3. The I signal I12 and the Q signal Q12 generated from the calibration system 200 balance the I signal I3 and the Q signal Q3 after mixing, which is the target that the input nodes of the vector analyzer 1510 are disposed for receiving the signals 13 and Q3. The addition circuit S1 adds the received I signal I11 to the received Q signal Q11 for outputting the signal C1 and thus the communication quality is improved.

Additionally, the delay circuits D2 and D3 can be realized with a polyphase filter, a mixer, or a frequency divider for achieving the function of phase delaying.

To sum up, the present invention improve the imbalance between the I signal and the Q signal by a method which can adjust the phase and the amplitude independently instead of the recursive method. Therefore, the present invention provides a high convenience and improves the communication quality.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for adjusting a set of an in-phase signal and a quadrature-phase signal, comprising:
receiving a phase control signal;
receiving an amplitude control signal;
receiving a first in-phase signal;
delaying a phase of the first in-phase signal by a predetermined angle for generating a first delayed in-phase signal;
adjusting an amplitude of the first in-phase signal for generating a second in-phase signal according to the phase control signal and the amplitude control signal;
adjusting an amplitude of the first delayed in-phase signal for generating a second delayed in-phase signal according to the phase control signal and the amplitude control signal;
adding the second in-phase signal to the second delayed in-phase signal for generating a third in-phase signal;
outputting the third in-phase signal;
receiving a first quadrature-phase signal;
delaying a phase of the first quadrature-phase signal by a predetermined angle for generating a first delayed quadrature-phase signal;
adjusting an amplitude of the first quadrature-phase signal for generating a second quadrature-phase signal according to the phase control signal and the amplitude control signal;
adjusting an amplitude of the first delayed quadrature-phase signal for generating a second delayed quadrature-phase signal according to the phase control signal and the amplitude control signal;
adding the second quadrature-phase signal to the second delayed quadrature-phase signal for generating a third quadrature-phase signal; and
outputting the third quadrature-phase signal.

2. The method of claim 1 wherein delaying the phase of the first in-phase signal for generating the first delayed in-phase signal further comprises:
inputting the first in-phase signal to a polyphase filter, a mixer, or a frequency divider for generating a first delayed in-phase signal.

3. The method of claim 1 wherein adjusting the amplitude of the first in-phase signal for generating the second in-phase signal according to the phase control signal and the amplitude control signal further comprises:
inputting the first in-phase signal into an amplifier for generating the second in-phase signal;
wherein a gain of the amplifier is controlled by the phase control signal and the amplitude control signal.

4. The method of claim 1 wherein adjusting the amplitude of the first in-phase signal for generating the second delayed in-phase signal according to the phase control signal and the amplitude control signal further comprises:
inputting the first delayed in-phase signal into an amplifier for generating the second delayed in-phase signal;
wherein a gain of the amplifier is controlled by the phase control signal and the amplitude control signal.

5. The method of claim 1 wherein delaying the phase of the first quadrature-phase signal for generating the first delayed quadrature-phase signal further comprises:
inputting the first quadrature-phase signal to a polyphase filter, a mixer, or a frequency divider for generating a first delayed quadrature-phase signal.

6. The method of claim 1 wherein adjusting the amplitude of the first quadrature-phase signal for generating the second quadrature-phase signal according to the phase control signal and the amplitude control signal further comprises:
inputting the first quadrature-phase signal into an amplifier for generating the second quadrature-phase signal;
wherein a gain of the amplifier is controlled by the phase control signal and the amplitude control signal.

7. The method of claim 1 wherein adjusting the amplitude of the first quadrature-phase signal for generating the second delayed quadrature-phase signal according to the phase control signal and the amplitude control signal further comprises:
inputting the first delayed quadrature-phase signal into an amplifier for generating the second delayed quadrature-phase signal;
wherein a gain of the amplifier is controlled by the phase control signal and the amplitude control signal.

8. The method of claim 1 wherein receiving the phase control signal comprises receiving a signal indicating a phase difference between the first in-phase signal and the first quadrature-phase signal.

9. The method of claim 1 wherein receiving the amplitude control signal comprises receiving a signal indicating an amplitude difference between the first in-phase signal and the first quadrature-phase signal.

10. The method of claim 1 wherein receiving the phase control signal comprises receiving a signal indicating a phase difference between an in-phase carrier signal and a quadrature-phase carrier signal.

11. The method of claim 9 wherein receiving the amplitude control signal comprises receiving a signal indicating an amplitude difference between an in-phase carrier signal and a quadrature-phase carrier signal.
